(19) United States
(12) Patent Application Publication
(10) Pub. No.: US 2026/0340521 A1
(43) Pub. Date: Oct. 29, 2026

(54) SYSTEM AND METHOD FOR AN ON-DEMAND PICK-AND-DROP SERVICE

(71) Applicant: Israel Miller, Sicklerville, NJ (US)

(72) Inventor: Israel Miller, Sicklerville, NJ (US)

(21) Appl. No.: 19/660,486

(22) Filed: Apr. 28, 2026

Related U.S. Application Data
(60) Provisional application No. 63/795,871, filed on Apr. 28, 2025.

(51) Int. Cl. G06Q 10/02; G06F 3/0483

(52) U.S. Cl. CPC G06Q 10/02; G06F 3/0483

(57) ABSTRACT

A system and method for an on-demand pick-and-drop service that easily requests pick-ups and drop-offs whenever needed, connecting to a network of trusted drivers committed to providing smooth and hassle-free deliveries. The overall system includes a plurality of pages residing on the on-demand pick-and-drop service non-transitory storage media that includes a home page, a customer application page, a driver application page, and a contact us page. The overall system includes a logistics and autonomous architecture having a vehicle input layer, a central cloud layer, and an autonomous readiness layer. The system and method also includes a non-transitory storage media to execute the overall method on the overall system.

### CROSS-REFERENCE TO RELATED APPLICATIONS

This U.S. Non-Provisional Application claims the benefit of U.S. Provisional Application No. 63/795,871 filed on Apr. 28, 2025. The above identified patent application is herein incorporated by reference in its entirety to provide continuity of disclosure.

### BACKGROUND OF THE INVENTION

The present invention is a system and method for an online service. More specifically, the present invention relates to a system and method for an on-demand pick-and-drop service.

In the age of ridesharing services such as Uber and Lyft, other auxiliary services are needed that are offshoots of ridesharing services.

What is needed is a system and method for an on-demand pick-and-drop service that can easily request pick-ups and drop-offs whenever needed, connecting to a network of trusted drivers committed to providing smooth, hassle-free deliveries.

### SUMMARY OF THE INVENTION

In view of the foregoing disadvantages inherent in the known types of systems and methods for an on-demand pick-and-drop service now present in the prior art, the present invention provides a system and method for an on-demand pick-and-drop service that offers enhanced efficiency, scalability, and real-time coordination between service providers and users.

The present invention is a system and method for an online service. More specifically, the present invention relates to a system and method for an on-demand pick-and-drop service.

The present invention is a system for an on-demand pick-and-drop service, comprising a server system with a processor system, a communications interface, a communications system, an input system and an output system, the server system having access to a communications network; a memory system with an operating system, a communications module, a web browser module, a web server application and an on-demand pick-and-drop service non-transitory storage media; and a plurality of pages residing on the on-demand pick-and-drop service non-transitory storage media is installed on.

The present invention is a corresponding method for an on-demand pick-and-drop service, comprising the steps of installing an on-demand pick-and-drop service non-transitory storage media on a client device.

The present invention is a corresponding non-transitory computer storage media having instructions stored thereon which, when executed, execute a method comprising the steps of installing an on-demand pick-and-drop service non-transitory storage media on a client device.

One object of the present invention is to provide a system and method for an on-demand pick-and-drop service that provides an integrated on-demand pick-and-drop service platform comprising a mobile application that facilitates user registration, service booking, and real-time tracking via a user-friendly home interface.

One object of the present invention is to provide a system and method for an on-demand pick-and-drop service that offers a customer application that enables seamless scheduling of pick-up and delivery services, view of transaction history, and real-time status monitoring through geolocation features.

One object of the present invention is to provide a system and method for an on-demand pick-and-drop service that manages backend application data, including user profiles, service requests, route planning, payment processing, and delivery confirmations in a secure and scalable database structure.

One object of the present invention is to provide a system and method for an on-demand pick-and-drop service that ensures enhanced user support through a dedicated “Contact Us” interface within the application, which allows users to initiate inquiries, service complaints, or support requests.

One object of the present invention is to provide a system and method for an on-demand pick-and-drop service that minimizes logistical inefficiencies by intelligently matching service requests with available drivers or carriers based on geographic proximity and time optimization algorithms.

One object of the present invention is to provide a system and method for an on-demand pick-and-drop service that enables automated push notifications, email alerts, and SMS updates to users regarding the status of their pick-up or delivery, including ETA updates and service confirmations.

One object of the present invention is to provide a system and method for an on-demand pick-and-drop service that supports both individual and commercial users with a platform that may accommodate bulk deliveries, multi-stop routing, and configurable pick-up/drop preferences.

One object of the present invention is to provide a system and method for an on-demand pick-and-drop service that implements a feedback and rating system that allows customers to review service providers, thereby maintaining service quality and accountability.

One object of the present invention is to provide a system and method for an on-demand pick-and-drop service that facilitates secure digital payments and electronic receipts through integration with third-party payment gateways and digital wallet systems.

One object of the present invention is to provide a system and method for an on-demand pick-and-drop service that allows administrators to configure operational parameters, pricing models, and service zones via a backend control panel linked to the application data infrastructure.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a system overview of a system for an on-demand pick-and-drop service, in accordance with one embodiment of the present invention.

FIG. 2A shows a block diagram of a client system, in accordance with one embodiment of the present invention.

FIG. 2B shows a block diagram of a server system, in accordance with one embodiment of the present invention.

FIG. 3 shows a home page of a system for an on-demand pick-and-drop service, in accordance with one embodiment of the present invention.

FIG. 4 shows a customer application page of a system for an on-demand pick-and-drop service, in accordance with one embodiment of the present invention.

FIG. 5 shows a driver application page of a system for an on-demand pick-and-drop service, in accordance with one embodiment of the present invention.

FIG. 6 shows a contact us page of a system for an on-demand pick-and-drop service, in accordance with one embodiment of the present invention.

FIG. 7 shows a logistics and autonomous architecture for a system for an on-demand pick-and-drop service, in accordance with one embodiment of the present invention.

FIG. 8 shows a logic flow for a method for an on-demand pick-and-drop service, in accordance with one embodiment of the present invention.

### DETAILED DESCRIPTION OF THE INVENTION

Reference is made herein to the attached drawings. Like reference numerals are used throughout the drawings to depict like or similar elements of a system and method for an on-demand pick-and-drop service. The figures are intended for representative purposes only and should not be considered to be limiting in any respect.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

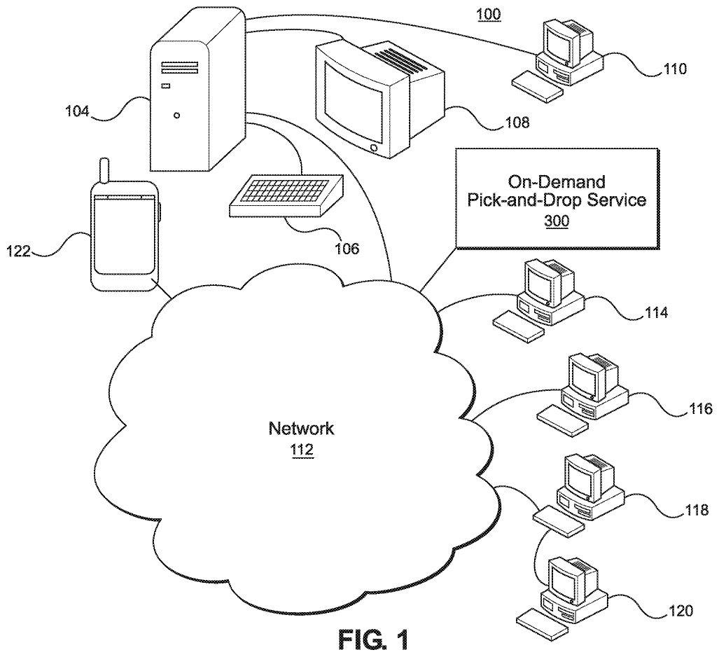

FIG. 1 illustrates a system overview of a system for an on-demand pick-and-drop service 100, in accordance with one embodiment of the present invention.

The overall system 100 includes a server system 104, an input system 106, an output system 108, a plurality of client systems 110, 114, 116, 118 and 120, a communications network 112 and a hand-held device 122. In other embodiments, the overall system 100 may include additional components and/or may not include all of the components listed above.

The server system 104 may include one or more servers. One server system 104 may be the property of the distributor of any related software or non-transitory storage media. In other embodiments, the overall system 100 may include additional components and/or may not include all of the components listed above.

The input system 106 may be used for entering input into the server system 104, and may include any one of, some of, any combination of, or all of a keyboard system, a mouse system, a track ball system, a track pad system, a plurality of buttons on a handheld system, a scanner system, a wireless receiver, a microphone system, a connection to a sound system, and/or a connection and/or an interface system to a computer system, an intranet, and/or the Internet (i.e., IrDA, USB), for example.

The output system 108 may be used for receiving output from the server system 104, and may include any one of, some of, any combination of or all of a monitor system, a wireless transmitter, a handheld display system, a printer system, a speaker system, a connection or an interface system to a sound system, an interface system to one or more peripheral devices and/or a connection and/or an interface system to a computer system, an intranet, and/or the Internet, for example.

The overall system 100 illustrates some of the variations of the manners of connecting to the server system 104, which may be an information providing website (not shown). The server system 104 may be directly connected and/or wirelessly connected to the plurality of client systems 110, 114, 116, 118 and 120 and are connected via the communications network 112. Client systems 120 may be connected to the server system 104 via the client system 118. The communications network 112 may be any one of, or any combination of, one or more local area networks or LANs, wide area networks or WANs, wireless networks, telephone networks, the Internet and/or other networks. The communications network 112 may include one or more wireless portals (not shown). The client systems 110, 114, 116, 118, and 120 are any system that an end user may use to access the server system 104. For example, the client systems 110, 114, 116, 118 and 120 may be personal computers, workstations, laptop computers, game consoles, handheld network enabled audio/video players and/or any other network appliance.

The client system 120 accesses the server system 104 via the combination of the communications network 112 and another system, which in this example is the client system 118. The client system 120 is an example of a handheld wireless device 122, such as a mobile phone or a handheld network enabled audio/music player or the like, which may also be used for accessing network content.

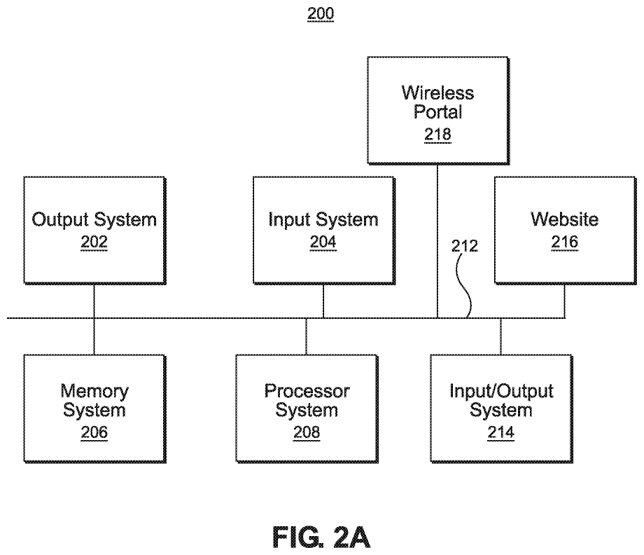

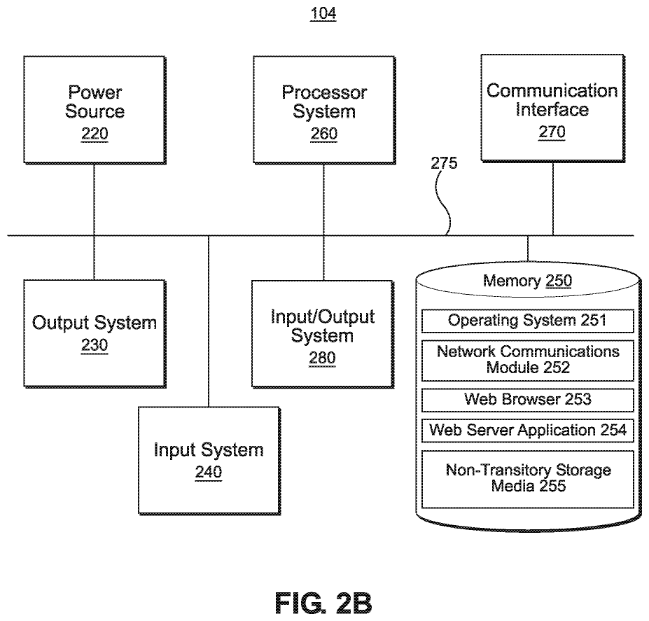

FIG. 2A illustrates a block diagram of a client system 200, in accordance with one embodiment of the present invention.

The client system 200 may include an output system 202, an input system 204, a memory system 206, a processor system 208, a communications system 212, an input/output system 214, a website 216, and a wireless portal 218. Other embodiments of the client system 200 may not have all of the components and/or may have other embodiments in addition to or instead of the components listed above.

The client system 200 may be any one of the client systems 110, 114, 116, 118, 120, and/or handheld wireless device 122 that may be used as one of the network devices of FIG. 1. In other embodiments, the client system 200 may include additional components and/or may not include all of the components listed above. The output system 202 may include any one of, some of, any combination of or all of a monitor system, a wireless transmitter, a handheld display system, a printer system, a speaker system, a connection or an interface system to a sound system, an interface system to peripheral devices and/or a connection and/or an interface system to a computer system, an intranet, and/or the Internet, for example.

The input system 204 may include any one of, some of, any combination of or all of a keyboard system, a mouse system, a track ball system, a track pad system, one or more buttons on a handheld system, a scanner system, a wireless receiver, a microphone system, a connection to a sound system, and/or a connection and/or an interface system to a computer system, an intranet, and/or the Internet (i.e., Infrared Data Association or lrDA, Universal Serial Bus or USB), for example. The memory system 206 may include, for example, any one of, some of, any combination of or all of a long-term storage system, such as a hard drive, a short-term storage system, such as a random-access memory; a removable storage system, such as a floppy drive or a removable drive, and/or a flash memory. The memory system 206 may include one or more machine readable machine-readable mediums that may store a variety of different types of information. The term machine readable machine-readable medium is used to refer to any medium that is structurally configured for carrying information in a format that is readable by a machine. One example of a machine-readable medium is a computer-readable medium. The memory system 206 also stores a non-transitory storage media for on-demand pick-and-drop service (FIGS. 2B, 255).

The processor system 208 may include any one of, some of, any combination of, or all of multiple parallel processors, a single processor, a system of processors having one or more central processors and/or one or more specialized processors dedicated to specific tasks. The processor system 208 implements the programs stored in the memory system 206. The communications system 212 communicatively buttons the output system 202, the input system 204, the memory system 206, the processor system 208, and/or the input/output system 214 to each other. The communications system 212 may include any one of, some of, any combination of, or all of one or more electrical cables, fiber optic cables, and/or means for sending signals through air or water (i.e., wireless communications), or the like. Some examples of means for sending signals through air and/or water include systems for transmitting electromagnetic waves such as infrared and/or radio waves and/or systems for sending sound waves.

The input/output system 214 may include devices that have the dual function as input and output devices. For example, the input/output system 214 may include one or more touch sensitive screens, which display an image and therefore are an output device and accept input when the screens are pressed by a finger or a stylus, for example. The touch sensitive screens may be sensitive to heat, capacitance and/or pressure. One or more of the input/output devices may be sensitive to a voltage or a current produced by a stylus, for example. The input/output system 214 is optional and may be used in addition to or in place of the output system 202 and/or the input device 204.

The client systems 110, 114, 116, 118, 120 and the handheld wireless device 122 may also be tied into a website 216 or a wireless portal 218 which is also tied directly into the communications system 212. Any website 216 or wireless portal 218 would also include software and a website module (no number) to maintain, allow access to and run the website as well.

FIG. 2B illustrates a block diagram of a server system 104, in accordance with one embodiment of the present invention.

The server system 104 may include a power source 220, an output system 230, an input system 240, a memory system 250, which may store an operating system 251, a communications module 252, a web browser module 253, a web server application 254, and a non-transitory storage media for on-demand pick-and-drop service 255. The server system 104 may also include a processor system 260, a communications interface 270, a communications system 275 and an input/output system 280. In other embodiments, the server system 104 may include additional components and/or may not include all of the components listed above.

The output system 230 may include any one of, some of, any combination of, or all of a monitor system, a handheld display system, a printer system, a speaker system, a connection or interface system to a sound system, an interface system to one or more peripheral devices and/or a connection and/or interface system to a computer system, an intranet, and/or the Internet, for example.

The input system 240 may include any one of, some of, any combination of, or all of a keyboard system, a mouse system, a track ball system, a track pad system, one or more buttons on a handheld system, a scanner system, a microphone system, a connection to a sound system, and/or a connection and/or an interface system to a computer system, an intranet, and/or the Internet (i.e., IrDA, USB), for example.

The memory system 250 may include, for example, any one of, some of, any combination of, or all of a long-term storage system, such as a hard drive; a short-term storage system, such as random-access memory; a removable storage system, such as a floppy drive or a removable drive and/or a flash memory. The memory system 250 may include one or more machine readable machine-readable mediums that may store a variety of different types of information. The term machine readable machine-readable medium is used to refer to any medium capable of carrying information that is readable by a machine. One example of a machine-readable medium is a computer-readable medium. The memory system 250 may store one or more machine instructions for on-demand pick-and-drop service. The operating system 251 controls all software or non-transitory storage media and hardware of the overall system 100. The communications module 252 may enable the server system 104 to communicate on the communications network 112. The web browser module 253 allows for browsing the Internet. The web server application 254 serves a plurality of web pages to client systems that request the webpages, thereby facilitating browsing on the Internet.

The processor system 260 may include any one of, some of, any combination of, or all of multiple parallel processors, a single processor, a system of processors having one or more central processors and/or one or more specialized processors dedicated to specific tasks. The processor system 260 may implement the machine instructions stored in the memory system 250.

In an alternative embodiment, the communication interface 270 allows the server system 104 to interface with the network 112. In this embodiment, the output system 230 sends communications to the communication interface 270. The communications system 275 communicatively buttons the output system 230, the input system 240, the memory system 250, the processor system 260 and/or the input/output system 280 to each other. The communications system 275 may include any one of, some of, any combination of, or all of one or more electrical cables, fiber optic cables, and/or sending signals through air or water (i.e., wireless communications), or the like. Some examples of sending signals through air and/or water include systems for transmitting electromagnetic waves such as infrared and/or radio waves and/or systems for sending sound waves and the like.

The input/output system 280 may include devices that have the dual function as the input and output devices. For example, the input/output system 280 may include one or more touch sensitive screens, which display an image and therefore are an output device and accept input when the screens are pressed by a finger or a stylus, for example. The touch sensitive screens may be sensitive to heat and/or pressure. One or more of the input/output devices may be sensitive to a voltage or a current produced by a stylus, for example. The input/output system is optional and may be used in addition to or in place of the output system 230 and/or the input device 240.

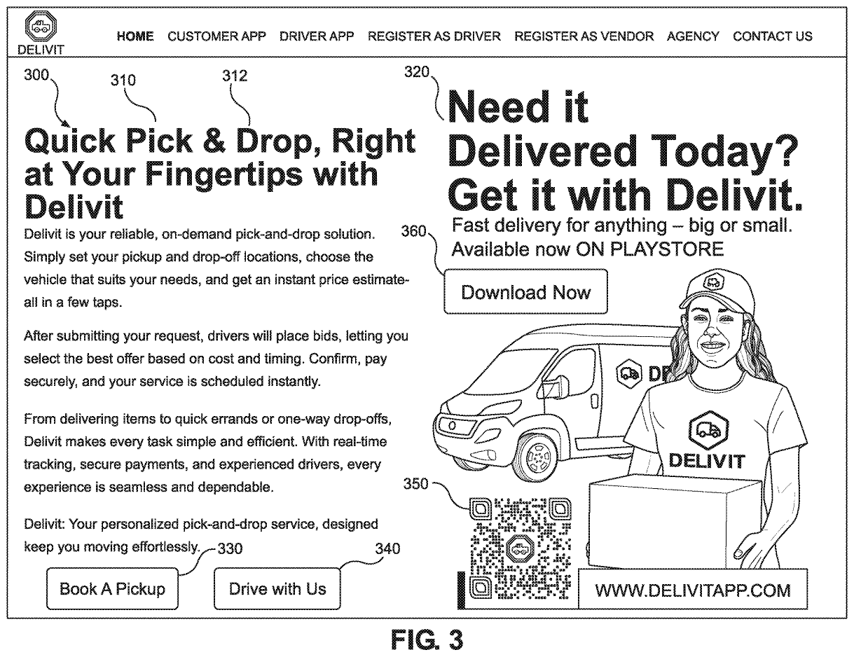

FIG. 3 shows a home page 300 of a system for an on-demand pick-and-drop service 100, in accordance with one embodiment of the present invention.

The home page 300 may include a first description 310 of the overall system 100, an illustration 320 of the overall system 100, a “Book a Pickup” button 330, a “Drive with Us” button 340, a Quick Release or QR Code 350, and a “Download Now” button 360.

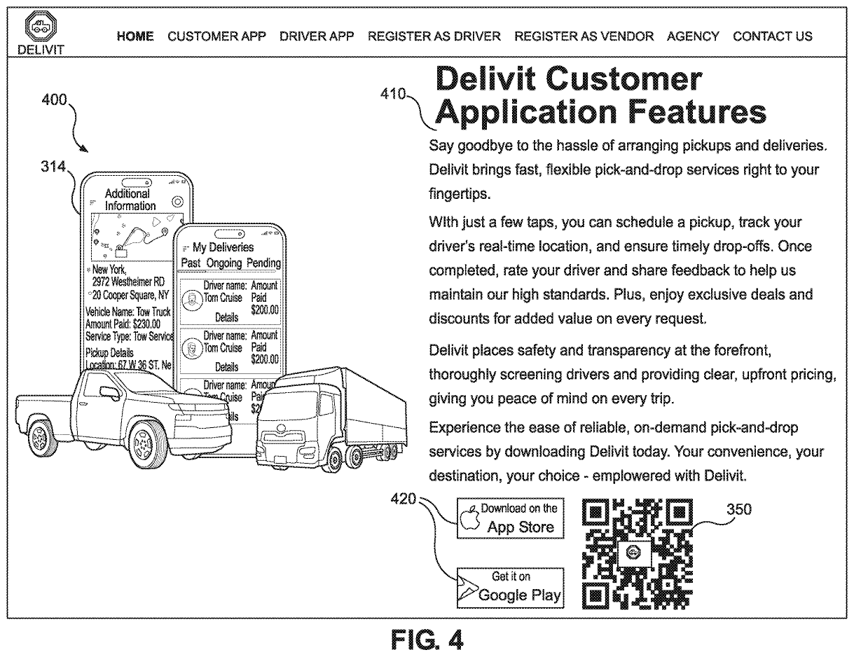

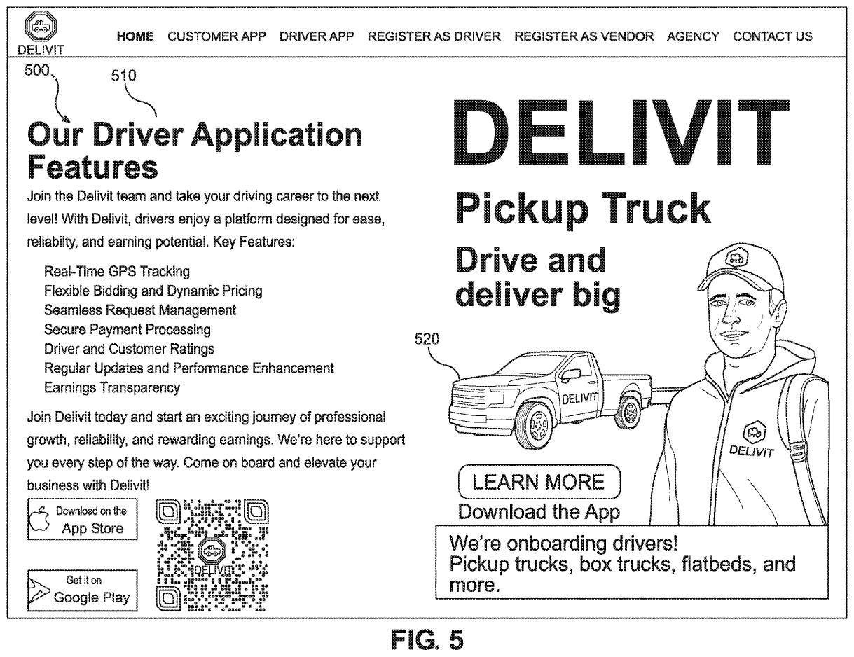

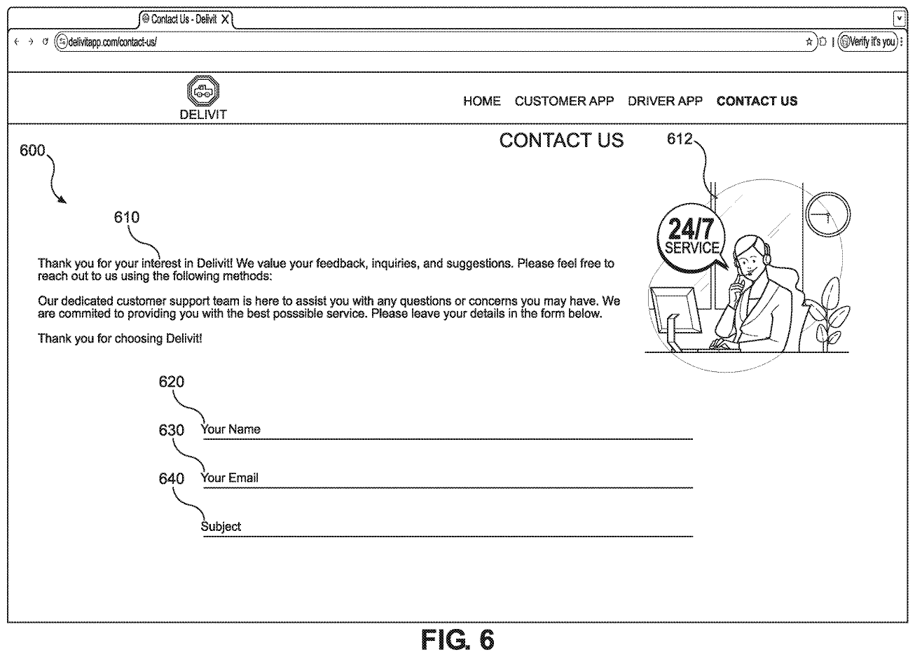

The description 310 may include a generic capability 312 of the overall system 100. The “Book a Pickup” button 330 may reside on the home page 300 and may be activated and configured for a user to schedule a pickup in the overall system 100. The “Drive with Us” button 340 may be activated and configured for a prospective driver to direct the prospective driver to an employment application (not shown). The QR Code 350 may be scanned by a mobile phone or the like to read the home page 300, the customer application page (FIGS. 4, 400), the driver application page (FIGS. 5, 500), and the contact us page (FIGS. 6, 600) of the overall system 100. The “Download Now” button 360 may reside on the home page 300 and may be activated and configured for the user to download a mobile app (FIGS. 4, 314) of the overall system 100.

FIG. 4 shows a customer application page 400 of a system for an on-demand pick-and-drop service 100, in accordance with one embodiment of the present invention.

The customer application page 400 may include a description 410 of the mobile app (FIGS. 3, 314) and a plurality of sources 420 to download the mobile app 314.

The description 410 of the mobile app 314 may describe the benefits of the mobile app 314. The sources 420 to download the mobile app 314 may include a digital storefront or the APP STORE® indicia, a digital content store or GOOGLE PLAY® indicia or the like as a functional indicia to describe where to download the mobile app 314.

FIG. 5 shows a driver application page 500 of a system for an on-demand pick-and-drop service 100, in accordance with one embodiment of the present invention.

The driver application page 500 may include a description of benefits and advantages 510 of the overall system 100 to the prospective driver and a “Learn More” button 520 that may be activated to provide more information about the overall system 100 to the prospective driver.

FIG. 6 shows a contact us page 600 of a system for an on-demand pick-and-drop service 100, in accordance with one embodiment of the present invention.

The contact us page 600 may include a thank you greeting 610, a name field 620, an email field 630, and a subject field 640.

The thank you greeting 610 may include an illustration 612 to further greet the user. The name field 620 may receive the name of the user with a customer service question. The email field 630 may receive the email of the user with the customer service question. The subject field 640 may receive the subject for the customer service question.

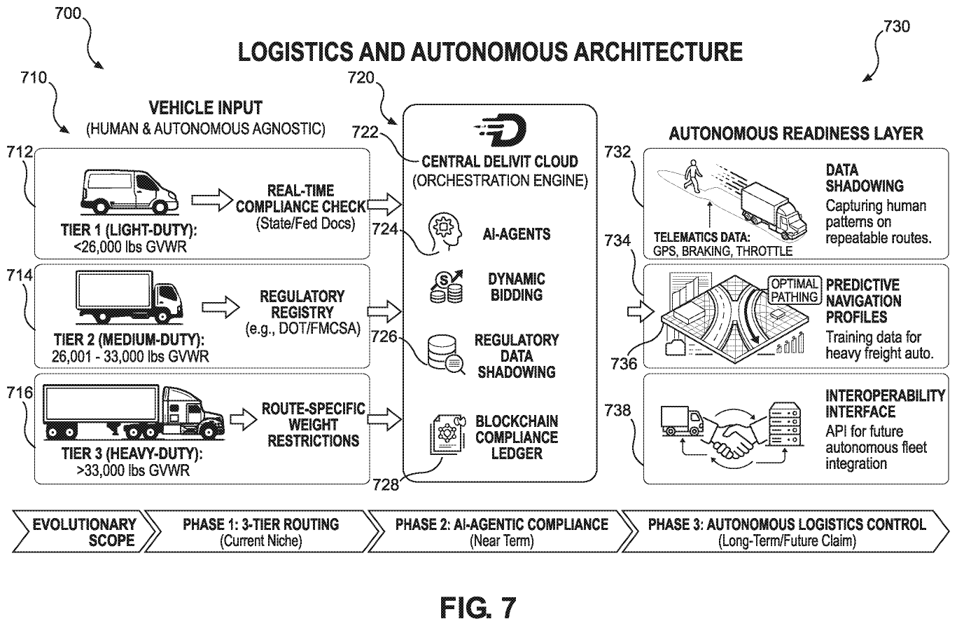

FIG. 7 shows a logistics and autonomous architecture 700 of a system for an on-demand pick-and-drop service 100, in accordance with one embodiment of the present invention.

The logistics and autonomous architecture 700 may include a vehicle input layer 710, a central cloud layer 720, and an autonomous readiness layer 730.

The vehicle input layer 710 may serve as a human and autonomous agnostic or the like. The vehicle input layer 710 may include a Tier 1 layer 712 for light-duty trucks of less than 26,000 lbs. Gross Vehicle Weight Rating or GVWR, a Tier 2 layer 714 for medium duty trucks between 26,001 lbs. and 33,000 lbs. GVWR, and a Tier 3 layer 716 for heavy duty trucks greater than 33,001 lbs. GVWR. The Tier 1 layer 712 may have a real-time compliance check supported by state and federal documents. The Tier 2 layer 714 may have a regulatory registry from the Department of Transportation or DOT, the Federal Motor Carrier Safety Administration or (FMCSA), or the like.

The central cloud layer 720 may serve as an orchestration engine or the like. The central cloud layer 720 may include one or more artificial intelligence agents 722, a dynamic bidding process 724, a regulatory data shadowing process 726, and a Blockchain compliance ledger 728.

The autonomous readiness layer 730 may include a data shadowing process 732, a plurality of predictive navigation profiles 734, and an interoperability interface 736. The data shadowing process 732 may capture human patterns on repeatable routes via a plurality of telematics data from a Global Positioning System or GPS, a braking system, a throttling system and the like. The predictive navigation profiles 734 may provide training data for heavy freight auto via optimal pathing or the like. The interoperability interface 736 may include an Application Programming Interface 738 or API for future autonomous fleet integration or the like.

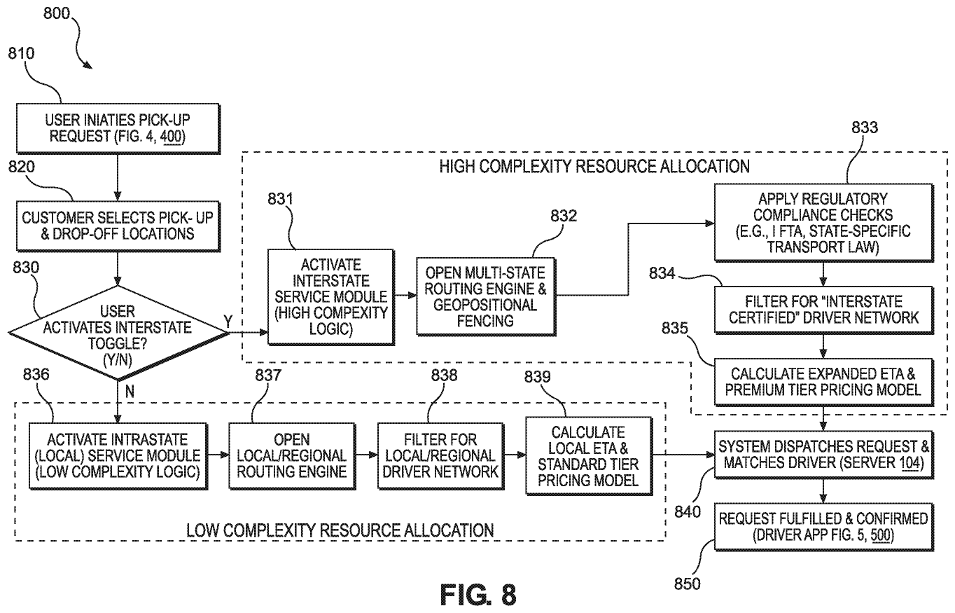

FIG. 8 shows a logic flow for a method for an on-demand pick-and-drop service 800, in accordance with one embodiment of the present invention.

The overall method 800 may comprise the steps of a user initiating a pickup request 810, a customer selecting one or more pick-up and drop-off locations 820, and the user deciding whether to activate an interstate toggle for a high complexity resource allocation or a low complexity resource allocation 830, dispatching with an overall system a request with a matching driver 840, and fulfilling and confirming a request 850.

The deciding step 830 may include activating an interstate toggle for a high complexity resource allocation by activating an interstate service module 831, opening a multi-state routing engine and geopositioned fencing 832, applying regulatory checks 833, filtering for interstate certified driver network 834, and calculating an expanded Estimated Time of Arrival or ETA and premium tier pricing model 835.

The deciding step 830 may include activating an interstate toggle for a low complexity resource allocation by activating an intrastate service module 836, opening a local or regional routing engine 837, filtering for a local or regional driver network 838, and calculating a local ETA and standard tier pricing model 839.

Therefore, the foregoing is considered as illustrative only of the principles of the invention. Furthermore, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A system for an on-demand pick-and-drop service, comprising:
a server system with a processor system, a communications interface, a communications system, an input system and an output system, the server system having access to a communications network;
a memory system with an operating system, a communications module, a web browser module, a web server application and an on-demand pick-and-drop service non-transitory storage media; and
a plurality of pages residing on the on-demand pick-and-drop service non-transitory storage media is installed on.

2. The system for an on-demand pick-and-drop service, according to claim 1, further comprising a client system that accesses the server system via the communications network.

3. The system for an on-demand pick-and-drop service, according to claim 2, wherein the client system is selected from the group consisting of a desktop computer, a laptop computer, or a smart phone.

4. The system for an on-demand pick-and-drop service, according to claim 1, wherein the pages include a home page, a customer application page, a driver application page, and a contact us page.

5. The system for an on-demand pick-and-drop service, according to claim 4, wherein the home page includes a first description of the overall system, an illustration of the overall system, a “Book a Pickup” button, a “Drive with Us” button, a QR Code, and a “Download Now” button.

6. The system for an on-demand pick-and-drop service, according to claim 4, wherein the customer application page includes a description of a mobile app and a plurality of sources to download the mobile app.

7. The system for an on-demand pick-and-drop service, according to claim 4, wherein the driver application page includes a description of benefits and advantages of the overall system to a prospective driver and a “Learn More” button that is activated to provide more information about the overall system to the prospective driver.

8. The system for an on-demand pick-and-drop service, according to claim 4, wherein the contact us page includes a thank you greeting, a name field, an email field, and a subject field.

9. The system for an on-demand pick-and-drop service, according to claim 1, further comprising a logistics and autonomous architecture.

10. The system for an on-demand pick-and-drop service, according to claim 9, wherein the logistics and autonomous architecture includes a vehicle input layer, a central cloud layer, and an autonomous readiness layer.

11. The system for an on-demand pick-and-drop service, according to claim 10, wherein the vehicle input layer serves as a human and autonomous agnostic.

12. The system for an on-demand pick-and-drop service, according to claim 10, wherein the vehicle input layer includes a Tier 1 layer for light-duty trucks of less than 26,000 lbs. Gross Vehicle Weight Rating or GVWR, a Tier 2 layer for medium duty trucks between 26,001 lbs. and 33,000 lbs. GVWR, and a Tier 3 layer for heavy duty trucks greater than 33,001 lbs. GVWR.

13. The system for an on-demand pick-and-drop service, according to claim 10, wherein the central cloud layer includes one or more artificial intelligence agents, a dynamic bidding process, a regulatory data shadowing process, and a Blockchain compliance ledger.

14. The system for an on-demand pick-and-drop service, according to claim 10, wherein the autonomous readiness layer includes a data shadowing process, a plurality of predictive navigation profiles, and an interoperability interface.

15. A method for an on-demand pick-and-drop service, comprising the steps of:
a user initiating a pickup request;
a customer selecting one or more pick-up and drop-off locations;
the user deciding whether to activate an interstate toggle for a high complexity resource allocation or a low complexity resource allocation;
dispatching with an overall system a request with a matching driver; and
fulfilling and confirming a request.

16. The method for an on-demand pick-and-drop service, according to claim 15, wherein the deciding step includes activating an interstate toggle for a high complexity resource allocation by activating an interstate service module, opening a multi-state routing engine and geopositioned fencing, applying regulatory checks, filtering for interstate certified driver network, and calculating an expanded ETA and premium tier pricing model.

17. The method for an on-demand pick-and-drop service, according to claim 15, wherein the deciding step includes activating an interstate toggle for a low complexity resource allocation by activating an intrastate service module, opening a local or regional routing engine, filtering for a local or regional driver network, and calculating a local ETA and standard tier pricing model.

18. A non-transitory computer storage media having instructions stored thereon which, when executed, execute a method comprising the steps of:
a user initiating a pickup request;
a customer selecting one or more pick-up and drop-off locations;
the user deciding whether to activate an interstate toggle for a high complexity resource allocation or a low complexity resource allocation;
dispatching with an overall system a request with a matching driver; and
fulfilling and confirming a request.

19. The non-transitory computer storage media, according to claim 18, wherein the deciding step includes activating an interstate toggle for a high complexity resource allocation by activating an interstate service module, opening a multi-state routing engine and geopositioned fencing, applying regulatory checks, filtering for an interstate certified driver network, and calculating an expanded ETA and premium tier pricing model.

20. The non-transitory computer storage media, according to claim 18, wherein the deciding step includes activating an interstate toggle for a low complexity resource allocation by activating an intrastate service module, opening a local or regional routing engine, filtering for a local or regional driver network, and calculating a local ETA and standard tier pricing model.
